(19) United States
(12) Patent Application Publication
(10) Pub. No.: US 2021/0226348 A1
(43) Pub. Date: Jul. 22, 2021

(54) WIRE HARNESS

(71) Applicant: SUMITOMO WIRING SYSTEMS, LTD., Yokkaichi-shi, Mie (JP)

(72) Inventor: Ryo KUROISHI, Yokkaichi-shi (JP)

(73) Assignee: SUMITOMO WIRING SYSTEMS, LTD., Yokkaichi-shi, Mie (JP)

(21) Appl. No.: 17/058,787

(22) PCT Filed: May 17, 2019
(86) PCT No.: PCT/JP2019/019650

§ 371 Date: Nov. 25, 2020

(30) Foreign Application Priority Data
Jun. 6, 2018 (JP) 2018-108608

(51) Int. Cl. H01R 4/02; H01R 4/72; H01B 7/00

(52) U.S. Cl. CPC H01R 4/021; H01B 7/0045; H01R 4/72

(57) ABSTRACT

A wire harness including: a first electric wire having a first core wire and a second electric wire having a second core wire, the first core wire and the second core wire being joined to each other, wherein: the first core wire has a planar portion extending over an entire length direction of the first core wire, the second core wire has flexibility higher than that of the first core wire, and an end of the second core wire is joined to the planar portion of the first core wire in an overlapped state therewith.

### BACKGROUND

The present disclosure relates to a wire harness.

An example of a known wire harness routed in a vehicle is a wire harness including a plurality of electric wires, with core wires of these electric wires being joined together (see JP 2016-58137A, for example). The wire harness described in JP 2016-58137A includes a stranded electric wire having a stranded wire in which a plurality of element wires are twisted as a core wire, and a solid-core electric wire having a solid-core wire with a circular cross-section as a core wire. An element wire exposed portion in which the element wires are exposed is provided at an end portion of the stranded electric wire. A conductor exposed portion in which a solid-core wire as a conductor is exposed is provided at an end portion of the solid-core electric wire. The conductor exposed portion is provided with a crushed portion, and the element wire exposed portion is joined to a planar portion of the crushed portion by ultrasonic welding.

### SUMMARY

In such a wire harness, a process of crushing the conductor exposed portion of the solid-core electric wire is required to join the core wires of the plurality of electric wires. In such a process, it is required to form the conductor exposed portion into a predetermined shape with high accuracy so that distortion does not occur in the joint portion between the core wires. Accordingly, the molding process tends to be complicated, and there is still room for improvement in easily manufacturing the wire harness.

An exemplary aspect of the disclosure provides a wire harness that can be manufactured by easily joining core wires to each other.

A wire harness according to an exemplary aspect includes a first electric wire having a first core wire and a second electric wire having a second core wire, the first core wire and the second core wire being joined to each other, wherein the first core wire has a planar portion extending over the entire length direction of the first core wire, the second core wire has flexibility higher than that of the first core wire, and an end of the second core wire is joined to the planar portion of the first core wire in an overlapped state therewith.

According to this configuration, because the first core wire has the planar portion extending over the entire length direction thereof, the end of the second core wire can be joined to any position of the planar portion. Further, according to the above configuration, by adopting the first core wire in which the planar portion is formed in advance, the processing accuracy of the planar portion can be easily improved. In addition, a step of forming a planar portion at the end of the first core wire prior to the step of joining the first core wire and the second core wire is not required. As a result, the core wires can be easily joined to each other to manufacture the wire harness.

In the above wire harness, it is preferable that the end of the second core wire is joined to an intermediate portion of the first core wire in the length direction.

According to this configuration, because the first core wire has the planar portion extending over the entire length direction thereof, the end of the second core wire can be joined to the intermediate portion of the first core wire in the length direction. With this configuration, the core wires can be easily joined at a branch portion of the wire harness. Therefore, the degree of freedom of the shape of the wire harness can be easily increased.

In the above wire harness, it is preferable that the first core wire has a plurality of the planar portions.

According to this configuration, because the first core wire has the plurality of planar portions, a portion of the first core wire to which the end of the second core wire can be joined increases. Therefore, the degree of freedom of the shape of the wire harness can be easily increased while using the first core wire having the planar portions.

In the above wire harness, it is preferable that a cross-sectional shape of the first core wire orthogonal to the length direction is rectangular.

According to this configuration, the rigidity of the first core wire is high in the cross-sectional shape, that is, in a direction along a long side (hereinafter, referred to as a long side direction) of the rectangle, and is low in a direction along a short side (hereinafter, referred to as a short side direction). This facilitates bending of the first core wire in the short side direction. Therefore, the degree of freedom in routing the wire harness can be increased.

In the above wire harness, it is preferable that the second core wire is a stranded wire formed by twisting a plurality of element wires.

A wire harness is often routed in a bent state for connection to a device.

According to the above configuration, the wire harness can be easily bent by the second core wire having excellent flexibility and bendability.

In the above wire harness, it is preferable that the wire harness further includes a third electric wire having a third core wire, wherein the third core wire has a planar portion extending over the entire length direction of the third core wire, and the planar portion of the third core wire is joined to the planar portion of the first core wire in an overlapped state therewith.

According to this configuration, because both of the first core wire and the third core wire have the planar portion extending over the entire length direction thereof, it is possible to overlap and join any portion of the planar portion of the third core wire to any portion of the planar portion of the first core wire. Further, another core wire can be joined to any portion of the planar portion of the third core wire.

According to the present disclosure, a wire harness can be manufactured by easily joining core wires to each other.

### BRIEF DESCRIPTION OF THE DRAWINGS

FIG. 1 is a perspective view of a wire harness according to a first embodiment in a state in which the wire harness is routed between devices.

FIG. 2 is an enlarged plan view mainly showing a joint portion between core wires of the wire harness of the embodiment.

FIG. 3 is an enlarged perspective view mainly showing a joint portion between core wires of a wire harness according to a second embodiment.

FIG. 4 is an enlarged side view mainly showing a joint portion between core wires of a wire harness according to a third embodiment.

FIG. 5 is a side view showing a joint portion between core wires of a wire harness according to a modification.

FIG. 6 is a side view showing a joint portion between core wires of a wire harness according to another modification.

FIG. 7 is a side view showing an end portion of the wire harness according to another modification.

### DETAILED DESCRIPTION OF EMBODIMENTS

### First Embodiment

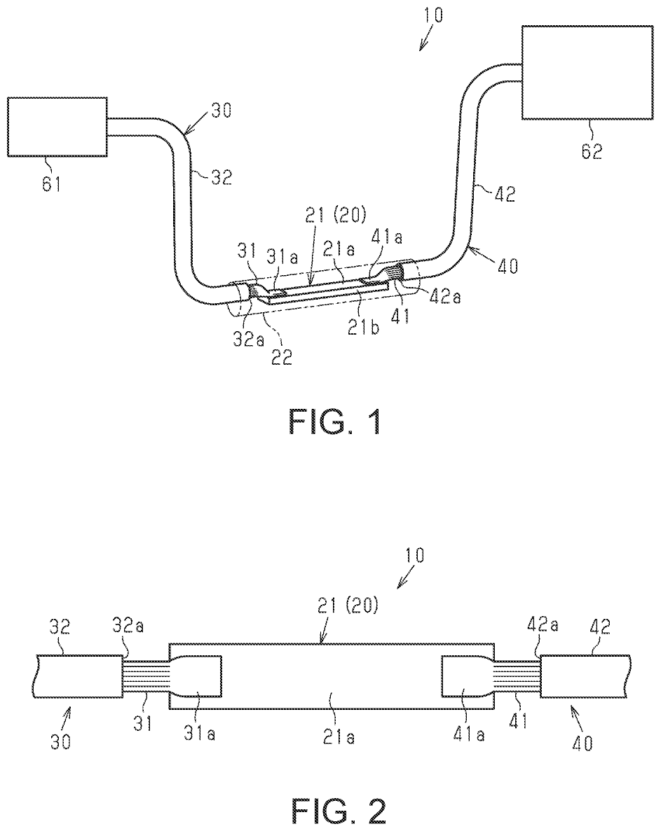

Hereinafter, a first embodiment of a wire harness will be described with reference to FIGS. 1 and 2.

As shown in FIG. 1, a wire harness 10 is routed in a vehicle such as a hybrid vehicle or an electric vehicle, and electrically connects devices 61 and 62 mounted in the vehicle to each other.

The wire harness 10 includes a first stranded electric wire 30 having one end connected to the device 61, a rectangular electric wire 20 having one end joined to the other end of the first stranded electric wire 30, and a second stranded electric wire 40 having one end joined to the other end of the rectangular electric wire 20 and the other end connected to the device 62.

The rectangular electric wire 20 corresponds to a first electric wire according to the present disclosure, and the first stranded electric wire 30 and the second stranded electric wire 40 correspond to a second electric wire according to the present disclosure.

The rectangular electric wire 20 includes a rectangular core wire 21 made of a metal material such as an aluminum alloy. The cross-sectional shape of the rectangular core wire 21 orthogonal to the length direction is the same rectangle throughout the entire length direction. The rectangular core wire 21 has four planar portions 21a and 21b extending over the entire length direction. In the following description, of the four planar portions 21a and 21b, a pair of planar portions including the long sides of the rectangle will be referred to as a first planar portion 21a, and a pair of planar portions including the short sides of the rectangular will be referred to as a second planar portion 21b.

The stranded electric wires 30 and 40 respectively include stranded core wires 31 and 41, and insulating coverings 32 and 42 that respectively cover the outer circumference of the stranded core wires 31 and 41. The stranded core wires 31 and 41 are made of, for example, stranded wires formed by twisting a plurality of metal element wires made of a copper alloy, and have flexibility higher than that of the rectangular electric wire 20. Terminals (not shown) connected to the devices 61 and 62 are fixed to the ends of the stranded core wires 31 and 41, respectively. The insulating coverings 32 and 42 are made of an electrically insulating synthetic resin, and have a cylindrical shape.

The rectangular core wire 21 corresponds to a first core wire according to the present disclosure, and the stranded core wires 31 and 41 correspond to a second core wire according to the present disclosure.

Next, the manner of joining the stranded electric wires 30 and 40 to the rectangular electric wire 20 will be described in detail.

As shown in FIG. 1, at the end portion of the first stranded electric wire 30, an end portion 31a of the stranded core wire 31 is exposed from the insulating covering 32. The end portion 31a is joined to one end of the first planar portion 21a of the rectangular core wire 21 by ultrasonic welding in an overlapped state therewith. As a result, the rectangular core wire 21 and the first stranded electric wire 30 are electrically connected to each other. The end portion 31a is crushed by being pressed together with the rectangular core wire 21 by a known ultrasonic welding jig (not shown). The height dimension (dimension in the vertical direction in FIG. 1) of the end portion 31a is formed to be smaller than other portions of the stranded core wire 31. Also, the width dimension (dimension in the vertical direction in FIG. 2) of the end portion 31a is formed to be larger than other portions of the stranded core wire 31. In the end portion 31a, the element wires of the strand core wire 31 are welded to each other.

As shown in FIG. 1, at the end portion of the second stranded electric wire 40, an end portion 41a of the stranded core wire 41 is exposed from the insulating covering 42. The end portion 41a is joined to the other end of the first planar portion 21a of the rectangular core wire 21 by ultrasonic welding in an overlapped state therewith. As a result, the rectangular core wire 21 and the second stranded electric wire 40 are electrically connected to each other.

The shape of the end portion 41a of the stranded core wire 41 and the joining manner of the end portion 41a and the first planar portion 21a of the rectangular core wire 21 are the same as the shape and the joining manner of the end portion 31a of the stranded core wire 31, and thus redundant description will be omitted.

As shown in FIG. 1, a portion between the end portion 32a of the insulating covering 32 of the first stranded electric wire 30 and the end portion 42a of the insulating covering 42 of the second stranded electric wire 40 is covered with a covering member 22 made of an electrically insulating heat-shrinkable tube. This prevents water or the like from entering the rectangular core wire 21 and the stranded core wires 31 and 41 exposed from the insulating coverings 32 and 42.

Next, the operation and effects of the present embodiment will be described.

(1) The wire harness 10 includes a rectangular electric wire 20 having a rectangular core wire 21 and a stranded electric wire 30 (40) having a stranded core wire 31 (41), and the rectangular core wire 21 and the stranded core wire 31 (41) are joined to each other. The rectangular core wire 21 has a first planar portion 21a extending over the entire length direction of the rectangular core wire 21. The stranded core wire 31 (41) has flexibility higher than that of the rectangular core wire 21, and an end portion 31a (41a) of the stranded core wire 31 (41) is joined to the first planar portion 21a in an overlapped state therewith.

According to such a configuration, because the rectangular core wire 21 has the first planar portion 21a extending over the entire length direction thereof, the end portion 31a (41a) of the stranded core wire 31 (41) can be joined to any position of the first planar portion 21a. In addition, according to the above configuration, by adopting the rectangular core wire 21 in which the first planar portion 21a is formed in advance, it is possible to easily improve the processing accuracy of the first planar portion 21a. Further, prior to the step of joining the rectangular core wire 21 and the stranded core wire 31 (41), a step of forming a planar portion at the end portion of the rectangular core wire 21 is not required. As a result, the core wires 21 and 31 (21 and 41) can be easily joined to each other to manufacture the wire harness 10.

(2) The rectangular core wire 21 has two first planar portions 21a.

According to such a configuration, because the rectangular core wire 21 has two first planar portions 21a, a portion of the rectangular core wire 21 to which the end portion 31a (41a) of the stranded core wire 31 (41) can be joined increases. Accordingly, the degree of freedom of the shape of the wire harness 10 can be easily increased while using the rectangular core wire 21 having the first planar portions 21a.

(3) The cross-sectional shape of the rectangular core wire 21 orthogonal to the length direction is rectangular.

According to such a configuration, the rigidity of the rectangular core wire 21 is high in the cross-sectional shape, that is, in a long side direction of the rectangle, and is low in a short side direction. This facilitates bending of the rectangular core wire 21 in the short side direction. Therefore, the degree of freedom in routing the wire harness 10 can be increased.

(4) The stranded core wire 31 (41) is a stranded wire formed by twisting a plurality of element wires.

A wire harness is often routed in a state in which an end portion of the wire harness is bent for connection to a device.

According to the above configuration, the end portion of the wire harness 10 can be easily bent by the stranded core wire 31 (41) having excellent flexibility and bendability.

### Second Embodiment

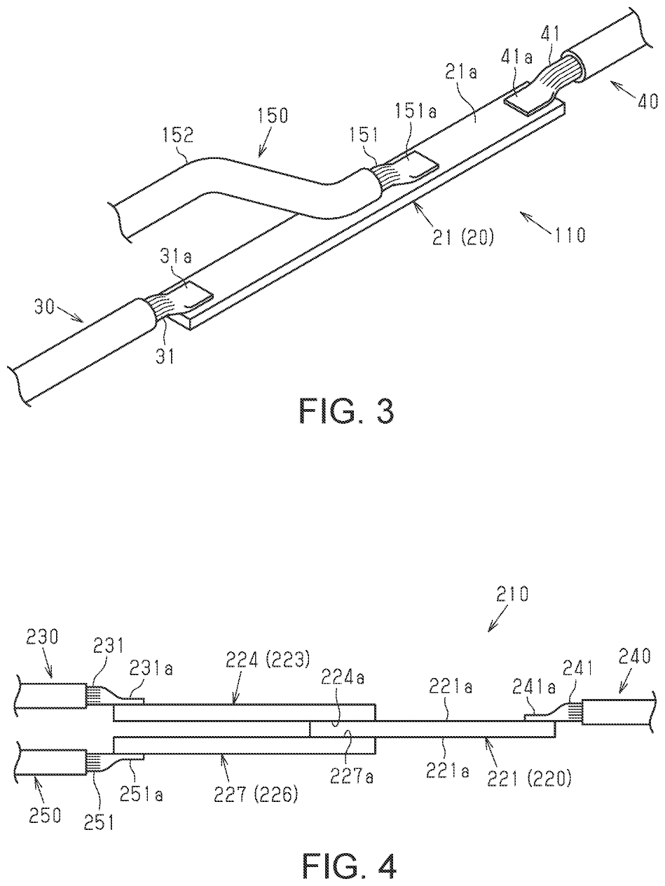

Hereinafter, with reference to FIG. 3, differences between a second embodiment of a wire harness and the first embodiment will be described. In the following description, the same or corresponding components as those of the first embodiment are denoted by the same reference numerals, and redundant description thereof will be omitted.

As shown in FIG. 3, a wire harness 110 includes a third stranded electric wire 150 to be connected to a device (not shown) different from the devices 61 and 62.

The third stranded electric wire 150 has the same configuration as those of the first and second stranded electric wires 30 and 40, and includes a stranded core wire 151 and an insulating covering 152.

An end portion 151a of the stranded core wire 151 is joined to an intermediate portion of the planar portion 21a in the length direction of the rectangular core wire 21 by ultrasonic welding an overlapped state therewith.

With the wire harness according to the present embodiment described above, in addition to the operation and effects (1) to (4) of the first embodiment, the following operation and effects are obtained.

(5) The end portion 151a of the stranded core wire 151 is joined to an intermediate portion of the rectangular core wire 21 in the length direction.

According to such a configuration, because the rectangular core wire 21 has the first planar portion 21a extending over the entire length direction thereof, the end portion 151a of the stranded core wire 151 can be joined to an intermediate portion of the rectangular core wire 21 in the length direction. As a result, the wire harness 110 can be easily joined at a branch portion. Therefore, the degree of freedom of the shape of the wire harness 110 can be easily increased.

### Third Embodiment

Hereinafter, with reference to FIG. 4, differences between a third embodiment of a wire harness and the first embodiment will be described.

As shown in FIG. 4, a wire harness 210 includes three stranded electric wires 230, 240, and 250 and three rectangular electric wires (a first rectangular electric wire 220, a second rectangular electric wire 223, and a third rectangular electric wire 226).

The rectangular electric wires 220, 223, and 226 respectively include rectangular core wires (a first rectangular core wire 221, a second rectangular core wire 224, and a third rectangular core wire 227) having the same configuration as the rectangular core wire 21 of the first embodiment.

The stranded electric wires 230, 240, and 250 have the same configuration as the stranded electric wires 30 and 40 of the first embodiment.

One end portion (right end portion in FIG. 4) of the first planar portions 224a and 227a of the second and third rectangular core wires 224 and 227 are joined to one end portion (left end portion in FIG. 4) of the pair of first planar portions 221a of the first rectangular core wire 221 by ultrasonic welding in an overlapped state.

The end portions 231a, 241a, and 251a of the stranded core wires 231, 241, and 251 of the stranded electric wires 230, 240, and 250 are joined to the end portions of the rectangular core wires 221, 224, and 227 opposite to the end portions joined to each other by ultrasonic welding in an overlapped state.

The first rectangular electric wire 220, the second rectangular electric wire 223, and the third rectangular electric wire 226 correspond to the first electric wire and a third electric wire according to the present disclosure, and the first rectangular core wire 221, the second rectangular core wire 224, and the third rectangular core wire 227 correspond to the first core wire and a third core wire according to the present disclosure.

With the wire harness according to the present embodiment described above, in addition to the operation and effects (1) to (5) of the first embodiment and the second embodiment, the following operation and effects are obtained.

(6) The wire harness 210 further includes second and third rectangular electric wires 223 and 226 respectively having second and third rectangular core wires 224 and 227. The second and third rectangular core wires 224 and 227 respectively have first planar portions 224a and 227a extending over the entire length direction of the second and third rectangular core wires 224 and 227. In addition, the first planar portions 224a and 227a of the second and third rectangular core wires 224 and 227 are joined to the first planar portion 221a of the first rectangular core wire 221 in an overlapped state therewith.

According to such a configuration, the first rectangular core wire 221 and both the second and third rectangular core wires 224 and 227 respectively have the first planar portions 221a, 224a, and 227a extending over the entire length direction thereof. Accordingly, the first planar portions 224a and 227a of the second and third rectangular core wires 224 and 227 can be overlapped and joined to any positions of the first planar portions 221a of the first rectangular core wire 221. In addition, other core wires can be joined to any positions of the first planar portions 224a and 227a of the second and third rectangular core wires 224 and 227.

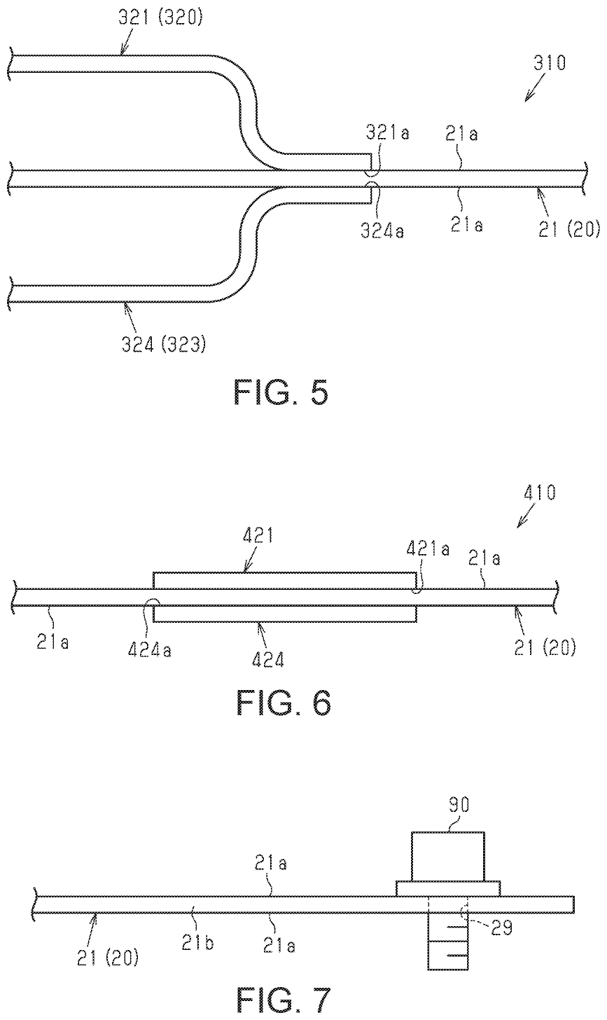

The present embodiment can be modified as follows. The embodiments and the following modifications can be implemented in combination with each other as long as no technical conflicts occur. In the following description, the same or corresponding components as those of the first embodiment are denoted by the same reference numerals, and redundant description thereof will be omitted.
As shown in FIG. 5, in a wire harness 310, the end portions of planar portions 321a and 324a of rectangular core wires 321 and 324 constituting a pair of rectangular electric wires 320 and 323 may be respectively joined to both of the pair of planar portions 21a of the rectangular core wire 21. In this case, because the above operation and effect (3) is achieved, the rectangular core wires 321 and 324 can be appropriately bent and routed.
As shown in FIG. 6, planar portions 421a and 424a of a pair of rectangular core wires 421 and 424 may be joined to a portion of both of the pair of first planar portions 21a of the rectangular core wire 21 in the length direction thereof. According to such a configuration, the heat capacity of the electric wires constituting a wire harness 410 is partially increased. As a result, it is possible to suppress a temperature rise of a portion of the wire harness 410 that is likely to increase in temperature.
As shown in FIG. 7, a communication hole 29 may be formed through the rectangular core wire 21 in the thickness direction. In this case, the rectangular electric wire 20 can be attached to an attachment target of the vehicle by a screw 90 inserted through the communication hole 29.
The rectangular electric wire 20 may have an insulating covering that covers the outer circumference of the rectangular core wire 21, similarly to the stranded electric wires 30 and 40. In this case, the insulating covering of the portion of the rectangular core wire 21 to be joined to the second core wire such as the stranded core wires 31 and 41 may be partially removed.
In the above embodiment, as an example of the first core wire according to the present disclosure, the rectangular core wire 21 having a rectangular cross-sectional shape orthogonal to the length direction has been described. However, the first core wire may have any shape as long as the first core wire has a planar portion, and for example, the cross-sectional shape orthogonal to the length direction may also be a square or a trapezoid.
In the above embodiment, as an example of the second core wire according to the present disclosure, the stranded core wires 31 and 41 formed by twisting a plurality of element wires have been described. However, the second electric wire may have flexibility higher than that of the first electric wire, and may be, for example, a braided member formed by braiding conductive element wires into a tubular shape.
The method of joining the core wires is not limited to ultrasonic welding, and other joining methods such as laser welding can also be used.
The rectangular core wires 21, 221, 224, 227, 321, 324, 421, and 424 of the illustrated embodiments are representative examples of conductive metal plates. The rectangular core wires 21, 221, 224, 227, 321, 324, 421, and 424 of the illustrated embodiments can have first and second major surfaces, first and second elongated side surfaces, and first and second end surfaces. The planar portions 21a, 221a, 224a, and 227a of the illustrated embodiments are representative examples of the first and second major surfaces of the conductive metal plate. The planar portion 21b of the illustrated embodiments is a representative example of the first and second elongated side surfaces of the conductive metal plate. In the rectangular core wires of the illustrated embodiments, both end surfaces in the longitudinal direction are representative examples of the first and second end surfaces of the conductive metal plate. On the first and second major surfaces, a range of a selected distance from the first end surface (for example, a range of length corresponding to the length of the flat joining surface of the end portion 31a of the stranded core wire 31) may be referred to as a first end of the conductive metal plate. On the first and second major surfaces, a range of a selected distance from the second end surface (for example, a range of length corresponding to the length of the flat joining surface of the end portion 41a of the stranded core wire 41) may be referred to as a second end of the conductive metal plate.

The present disclosure encompasses the following implementations. The reference numerals of representative components of the representative embodiments have been provided not by way of limitation but to aid in understanding.

### Supplementary Note 1

A wire harness (10) according to a non-limiting embodiment, including:

a metal stranded wire (31) having an end portion (31a); and

a conductive metal plate (21) having a first end surface, a second end surface, a length defined by the first end surface and the second end surface, a first major surface, a second major surface, a constant thickness defined by the first major surface and the second major surface, and a width that is constant over the length,

wherein the end portion (31a) of the metal stranded wire (31) may be overlapped with the first major surface in the vicinity of the first end surface of the conductive metal plate (21) and electrically and mechanically connected to the first major surface.

### Supplementary Note 2

The end portion (31a) of the metal stranded wire (31) may have a maximum width narrower than the width of the conductive metal plate (21).

### Supplementary Note 3

The metal stranded wire (31) may have a non-end portion excluding the end portion (31a), and the end portion (31a) of the metal stranded wire (31) may be a crushed end portion thinner than the non-end portion.

### Supplementary Note 4

The metal stranded wire (31) may be a first metal stranded wire (31), and the wire harness (10) may further include a second metal stranded wire (41) having an end portion (41a) that is overlapped with the first major surface of the conductive metal plate (21) at the second end of the conductive metal plate (21) and electrically and mechanically connected to the first major surface.

### Supplementary Note 5

The metal stranded wire (31) may be the first metal stranded wire (31), and the wire harness (10) may further include a third metal stranded wire (151) having an end portion (151a) that is overlapped with the first major surface of the conductive metal plate (21) at an intermediate portion in the longitudinal direction of the conductive metal plate (21) and electrically and mechanically connected to the first major surface.

### Supplementary Note 6

The wire harness (10) is configured to be routed along a predetermined routing path including at least one linear portion, and the conductive metal plate (21) may be a linear plate adapted to the at least one linear portion of the predetermined routing path.

### Supplementary Note 7

The wire harness may be configured to be routed along a predetermined routing path including an underfloor portion of the vehicle, and the conductive metal plate may be configured to maintain a shape conforming to a path of the entire underfloor portion or a predetermined portion of the predetermined routing path.

It will be apparent to those skilled in the art that the present disclosure may be embodied in other specific forms without departing from the spirit of essential characteristics thereof. For example, some of the components described in the embodiments (or one or more aspects thereof) may be omitted, or some components may be combined. The scope of the present disclosure should be determined with reference to the appended claims, along with the full scope of equivalents to which such claims are entitled.

1. A wire harness comprising:
a first electric wire having a first core wire and a second electric wire having a second core wire, the first core wire and the second core wire being joined to each other, wherein:
the first core wire has a planar portion extending over an entire length direction of the first core wire,
the second core wire has flexibility higher than that of the first core wire, and
an end of the second core wire is joined to the planar portion of the first core wire in an overlapped state therewith.

2. The wire harness according to claim 1, wherein
the end of the second core wire is joined to an intermediate portion of the first core wire in the length direction.

3. The wire harness according to claim 1, wherein
the planar portion the first core wire includes a plurality of planar portions.

4. The wire harness according to claim 3, wherein
a cross-sectional shape of the first core wire orthogonal to the length direction is rectangular.

5. The wire harness according to claim 1, wherein
the second core wire is a stranded wire formed by twisting a plurality of element wires.

6. The wire harness according to claim 1, further comprising
a third electric wire having a third core wire, wherein:
the third core wire has a planar portion extending over an entire length direction of the third core wire, and
the planar portion of the third core wire is joined to the planar portion of the first core wire in an overlapped state therewith.

7. The wire harness according to claim 1, wherein
the planar portion of the first core wire includes a pair of planar portions of the first core wire that are on opposite sides to each other, and
planar portions of a pair of rectangular core wires are joined in an overlapped state to the pair of planar portions of the first core wire.

8. The wire harness according to claim 1, wherein
the end of the second core wire is joined to the planar portion of the first core wire by ultrasonic welding or laser welding in an overlapped state therewith.

9. The wire harness according to claim 1, wherein
at least a portion where the first core wire and the second core wire are joined to each other is covered with an electrically insulating heat-shrinkable tube in a water-stopping manner.
